(19) United States
(12) Patent Application Publication
(10) Pub. No.: US 2016/0193906 A1
(43) Pub. Date: Jul. 7, 2016

(54) THE FOUR SIDE SHADES

(71) Applicant: ANTHONY SWAN, Lauderhill, FL (US)

(72) Inventor: ANTHONY SWAN, Lauderhill, FL (US)

(21) Appl. No.: 14/544,413

(22) Filed: Jan. 5, 2015

(51) Int. Cl. B60J 11/08; H02S 10/40; F16B 1/00

(52) U.S. Cl. CPC B60J 11/08; F16B 1/00; H02S 10/40; F16B 2001/0035

(57) ABSTRACT

A remote controlled four piece system that adheres to each window area of a vehicle with the use of magnets to keep out the harmful rays and heat of the sun. Uses the sun to power it's automated functions with the use of a remote and is held to any vehicle with the use of magnets. The shades are immersed and retracted to cover the window areas of a vehicle with the push of a button to allow a much better way to shield the interior of vehicle better than any sun visor.

### BACKGROUND OF THE INVENTION

This invention pertains to the field of heat prevention within the interior of vehicles.

### FIELD OF INVENTION

My invention relates to the field of heat prevention within the interior of vehicles.

### BRIEF SUMMARY OF THE INVENTION

As stated in the background of the invention, there are many existing products that are meant to reduce the heat in cars and trucks which many are not as effective as they claim to be. My invention allows for the full coverage of the windows of a car or truck. It is meant to be made in universal measurements that will allow for all of the window areas to be covered What is meant by full coverage is that of the windows where the doors are located and along with the back window and the windshield are to be covered in their entirety With the use of magnets, sensors, motors, solar cells, and a remote which the magnets allow for the invention sit securely on top of the car or truck to cover the windows of the vehicle and the solar cells to provide power from the sun to power the invention and the use of the remote to trigger the functions of the invention.

### BRIEF DESCRIPTION OF THE VIEWS OF THE DRAWINGS

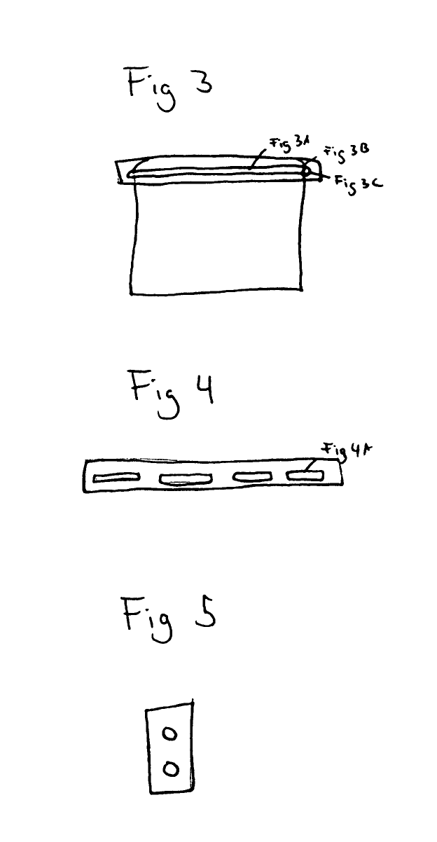

The drawings that are depicted are of the invention placed on top of the vehicle. The top drawing shows what the invention will look when the shades are not immersed on to the vehicle windows. The picture directly below it shows how the shades will be extended and rest upon the vehicle windows shading the interior car from the suns' rays and generated heat. The second page of drawings shows what the interior of the plastic compartment will look like with the inner workings which is labeled as FIG. 3. FIG. 4 shows the bottom area of the plastic compartment. What is shown here is the placement of the magnets as it relates to it being placed on the four sides of the vehicle to allow it be securely adhered to it. FIG. 5 is the remote control for the use of my invention. There are to be two buttons on the remote. One button causes the expulsion of the shades onto the vehicle windows in a synchronized fashion and the other button causes them to retract back into the plastic compartments in synchronized fashion.

### DETAILED DESCRIPTION OF THE INVENTION

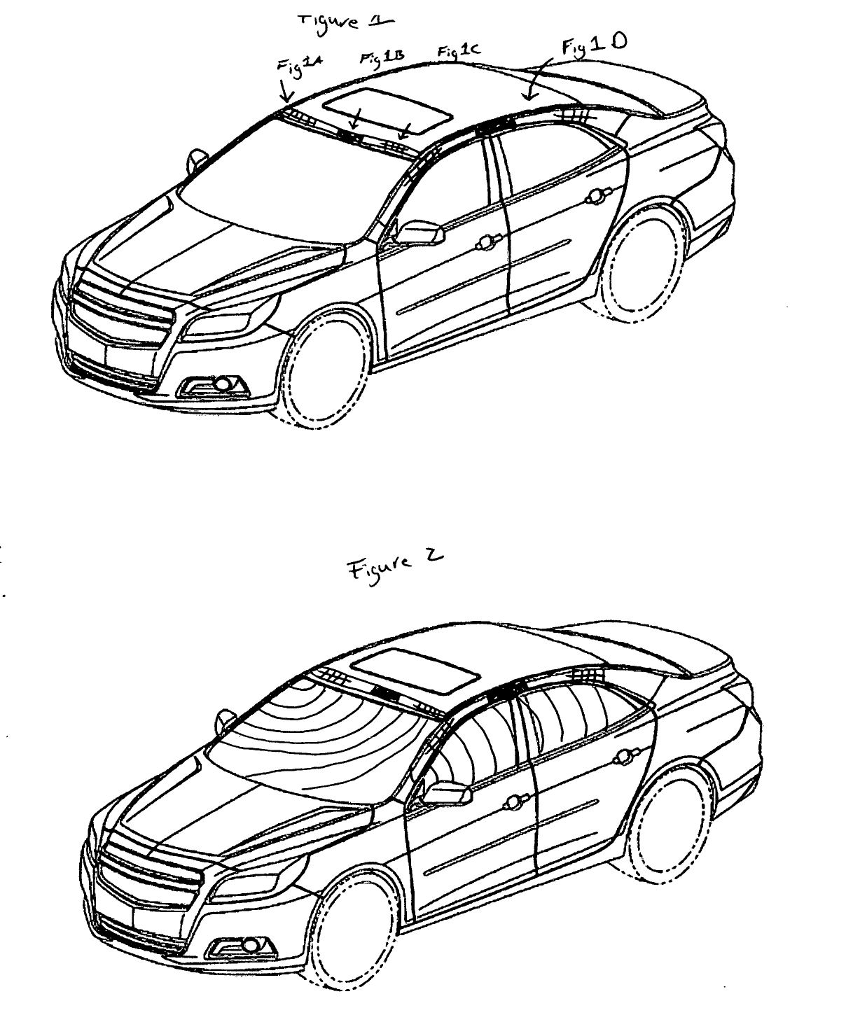

The first aspect of this invention that will be explained will be the solar panels. In the drawings labeled FIG. 1 and FIG. 2, the solar panels are labeled as FIG. 1C. Both FIGS. 1 and 2 are of the same thing and each component is represented in both drawings. The only difference being FIG. 1 shows the vehicle windows not being covered while FIG. 2 illustrates what it will look like with the vehicle windows covered. The invention is meant to protect the interior of the vehicle from the sun and the heat that accumulates within the inferior of the car. This invention uses what it protects from which is the sun to power its functions to protect it from the same thing. The use of solar panels eliminates the need for batteries and any other extra expense for the consumer when it comes to power the function of the invention. There are the placements of the eight 6 volt solar panels to allow for there to be ample accumulation of the suns' rays in order to power the invention. The solar panels will be rectangular shaped and placed on the opposite ends of the plastic compartments. The opposite ends correspond to the motors placed within the plastic compartments so that the invention can be powered. There are two solar panels placed on each opposite end on each of the plastic compartments for a total of eight solar panels. The connection of the 6 volt solar panels will be connected to the motors by someone skilled in that field. The method of connection from the solar panels will be allowed by openings that made into the plastic compartment to allow the wires to reach and be connected to the motors which allow for them to be powered and perform the intended functions of releasing and retracting the shades on and off the vehicle.

The next part of the invention are the plastic compartments. In the FIG. 1 drawing, the plastic compartments are labeled as 1A. These plastic columns are constructed of a waterproof and element withstanding composition of plastic. These plastic compartments house the inner workings that are required for the invention to work. These inner workings are the shades, plastic rods, the motors, and the wiring connections of the solar panels to the motors. The plastic columns contain and house these inner workings. The plastic columns are shaped in a rectangular fashion and made in a universal length to fit the roof areas of the vehicle for the windshield area and the back window area of the vehicle. The dimensions of the plastic compartments will be made in a universal dimension for the four top areas of vehicles. Each car and truck has varying dimensions. These four columns are made of lightweight, durable, and waterproof material. What is meant by a curvature is the area that vehicles have on the door area of the vehicle. The curve that is being indicated can be seen in the FIGS. 1 and 2 drawings where each car and truck as the area where the doors are located. The plastic columns will have an open area closest to the windows of the vehicle seen as that is meant to allow the shades to be extracted and retracted on to the windows of the car.

The next part of the invention would be the plastic rods that are labeled as 3A in the FIG. 3. The plastic rods are contained within the plastic columns. The plastic rods are rotated clockwise and counter clockwise by use of the motors. The motors are labeled 3C in the FIG. 3 drawing. The shades are meant to be rolled upon itself in the same like-minded method of a paper towel rolling back in forth in opposite directions as this rotation of the plastic rods takes place the shades will become immersed and retracted as such. The shades are adhered to the plastic rods by some bonding method and executed by someone skilled in that field which in return allow the shades to be extracted and retracted upon the vehicle windows. The motors are connected to the plastic rods by someone skilled in the area to allow the motors to cause the needed clockwise and counter clockwise motions that will in return expose and unexposed the shades on to the vehicle windows. The shades will immerse at a minimal speed in a synchronized fashion and return into the plastic compartment in the same synchronized minimal speed.

The next part of the invention is the use of magnets. We all know the relationship in regards to metal and magnets and it is for this reason magnets are used here. The magnets allow easy application and removal for the user. Vehicles are made of metal and it makes perfect sense to use them. Also, this avoids any type drilling or permanent application that the user may not want to be done to their car for whatever reason. The magnets will be one inch wide and three inches long. There will be four magnets that are placed on the underside of the plastic compartment. The layout is shown in the FIG. 4 drawing and FIG. 4A illustrates the magnets.

Finally, my invention has the use of a remote. All of the other products out there require the user to have to constantly manipulate which ever product they are using to cover their windows. Consumers do not have time to constantly adjust and readjust a shade in their windshield. With the use of a remote with my invention will allow the user to never have to touch the invention except in the times that they want to remove the invention from on top of their car. The remote is illustrated as FIG. 5 on page 2 of my drawings. The remote is responsible for the extraction and retraction movements of the shades. The remote is able to cause these actions by use of sensors placed on the top area of the plastic columns. There are four total sensors, one sensor is placed on each individual plastic column. These sensors are placed in the center of each of the plastic columns and represented as FIG. 1B in the FIG. 1 drawings. The user simply presses the buttons to cover and uncover their vehicle windows in the same manner as they would lock and unlock their vehicle doors.

### DESCRIPTION OF DRAWINGS

FIG. 1 represents the four side shades in the un-extended state on top of the vehicle.

FIG. 1A represents the plastic compartment that will rest upon the vehicle on the windshield and back window of the vehicle.

FIG. 1B represents the sensor and placement thereof that will initiate the actions of retraction and extraction of the shades on and off the vehicle

FIG. 1C represents the six volt rectangular solar panel cell that will allow the actions of retraction and extraction to take place of my, invention.

FIG. 1D represents the plastic compartment which has the same components and set up the same as. FIG. 1 with the only differences being the placement of the plastic compartment bring curved to fit the curvature of vehicle door windows. This plastic compartment is also placed on both door panel of the vehicle.

FIG. 2 represents the invention on top of the vehicle with the shades fully immersed.

FIG. 3 represents the interior of the plastic compartment.

FIG. 3A represents the plastic rod in which the shades are attached to which rotates to allow them to be extracted and retracted upon the vehicle windows.

FIG. 3B represents the placement of the wiring to the motors which rotate the plastic rods to allow the extraction and retraction of the shades on the vehicle windows.

### DESCRIPTION OF DRAWINGS

FIG. 1 represents the four side shades in the un-extended state on top of the vehicle.

FIG. 1A represents the plastic compartment that will rest upon the vehicle on the windshield and back window of the vehicle.

FIG. 1B represents the sensor and placement thereof that will initiate the actions of retraction and extraction of the shades on and off the vehicle

FIG. 1C represents the six volt rectangular solar panel cell that will allow the actions of retraction and extraction to take place of my invention.

FIG. 1D represents the plastic compartment which has the same components and set up the same as FIG. 1 with the only differences being the placement of the plastic compartment bring curved to fit the curvature of vehicle door windows. This plastic compartment is also placed on both door panel of the vehicle.

FIG. 2 represents the invention on top of the vehicle with the shades fully immersed.

FIG. 3 represents the interior of the plastic compartment.

FIG. 3A represents the plastic rod in which the shades are attached to which rotates to allow them to be extracted and retracted upon the vehicle windows.

FIG. 3B represents the placement of the wiring to the motors which rotate the plastic rods to allow the extraction and retraction of the shades on the vehicle windows.

FIG. 3C represents the motors that cause the rotation of the plastic rods to cause the extraction and retraction on top on the vehicle windows.

FIG. 4 represents the bottom of all the four plastic compartments illustrating the placement of the magnets that are meant to hold them on to the vehicle.

FIG. 5 represents the remote that I meant to trigger the extraction and retraction of the shades on top and off of the vehicle. One button will cover the windows and the press of the other button will uncover them.

1. I claim the use of four rectangular magnets measured to be one inch by three inches placed on the underside of each of the four plastic column compartments for a total of sixteen magnets so that it will allow for them to be held on to the roof of the vehicle.

2. I claim the four column compartments to contain the inner workings of the invention which are the shades, the solar panel, the motors which allows for the extraction and retraction of the shades, and the magnets which are placed on the underside to allow them to be held onto the vehicle.

3. I claim the use of four plastic column compartments made of a water proof and element withstanding plastic or some other waterproof material and made in varying dimensions due to vehicles having varying lengths in terms of the areas of the window areas.

4. I claim the use of four plastic compartments that are to placed at each side of the vehicle (windshield, back window, and door panel windows) on the top of the vehicle to allow the shades to be extracted and retracted upon the vehicle windows.

5. I claim the use of a remote control with two buttons; one causes the extraction of the shades, the other causes the retraction of the shades which is synced with the use of sensors that are placed upon the plastic by someone skilled in the field.

6. I claim the use of four shades that are placed within the four compartments which cover all the areas of the windows of the vehicle and extend onto and off of the vehicle windows.

7. I claim the use and placement of two polycrystalline 6 volt rectangular shaped solar cells panels on top of each plastic compartment for a total of eight polycrystalline 6 volt rectangular shaped solar cell panels. There will be one on each top side of the plastic compartments. Each solar cell panel will be connected to each motor on each side of the plastic compartment which allows for the movements and functions of the motors to be carried out.

8. I claim the construction of the two compartments which are intended to cover the windows located in the door panel area above the opening of the doors of the vehicle to be constructed in a curved fashion that is similar to that of the curvature of a vehicle where the doors exist so that it may allow for coverage of the door panel area in its' entirety.

9. I claim the invention to be used and placed on the exterior of the vehicle meaning the metals areas that run across the top areas of the windshield, back window, and the two door areas of the vehicle.

10. I claim the movement of the shades which is to extract themselves and retract themselves in a synchronized fashion.

11. I claim the two plastic compartments that are meant for the door windows of the vehicle to be placed exterior length of the doors so that the shades are able to cover them in their entirety or as close as possible.

12. I claim the shades being made of a lightweight, reflective, waterproof material, and element withstanding.

13. I claim the use and placement of sensors placed on the outer top layer of the four plastic compartments to cause the functions and movements of the shades in a synchronized fashion.

14. I claim the use of one sensor on each plastic compartment for a total of four sensors that will trigger the extraction and retraction of the shades upon and off the vehicle windows.

15. I claim the use of polycrystalline solar panels to be used to power the motors of the invention.
